(19) United States
(12) Patent Application Publication
(10) Pub. No.: US 2018/0167764 A1
(43) Pub. Date: Jun. 14, 2018

(54) REPELLENT SYSTEM

(71) Applicant: DIGISINE ENERGYTECH CO., LTD., New Taipei City (TW)

(72) Inventors: Chih-Hsien Wu, New Taipei City (TW); Yu-Hsun Lin, New Taipei City (TW); Shao-Kang Chung, New Taipei City (TW)

(21) Appl. No.: 15/415,812

(22) Filed: Jan. 25, 2017

(30) Foreign Application Priority Data
Dec. 8, 2016 (CN) 201611120632.7

(51) Int. Cl. H04W 4/00; A01M 23/00; A01M 29/16; A01M 29/18; A01M 29/22; A01M 29/10; A01M 29/12; A01M 1/00

(52) U.S. Cl. CPC H04W 4/008; A01M 23/00; A01M 29/16; A01M 29/18; H04W 84/18; A01M 29/10; A01M 29/12; A01M 1/00; A01M 29/22

(57) ABSTRACT

The repellent system includes a repellent device, a control device, a message device, and a power device. The repellent device is one for repelling or trapping animals or insects. The control device includes a processing module, a driver module, and a wireless communication module. The driver module is connected to the repellent device and is data-linked with the processing module. The wireless communication module is data-linked with the processing module. The message device communicating with the wireless communication module. The power device electrically connected to the processing module. A user, via the message device such as a cellular phone, obtains status data from the repellent device through the control device, and controls, configures, and adjusts the function and operation of the repellent device in a wireless and two-way interactive manner so that the convenience and applicability of the repellent device is greatly enhanced.

### BACKGROUND OF THE INVENTION

### (a) Technical Field of the Invention

The present invention is generally related to repellents, and more particular to a repellent system providing wireless interaction with user.

### (b) Description of the Prior Art

Wild animals or bird may damage or consume crops, spread diseases, cause traffic accidents, or even be harmful to children. Worldwide economic losses due to wild animals are staggering. To prevent wild animal intrusion, various repellents and repellants are employed, and electrical fences are deployed.

Take conventional bird repellents as an example, usually, the repellent is located at a specific location and an oscillator circuit is used to produce ultrasonic sound that would cause uncomfortableness to the birds.

Repellents for other animals or insects are structured and operated similarly. Their functions and operations are usually fixed and cannot be further controlled and adjusted, especially in a wireless manner. Their locations are as such also limited.

### SUMMARY OF THE INVENTION

An objective of the present invention is to provide a repellent system where an IoT (Internet of Things) control device provides wireless communication and control so that a user and a repellent device may communicate and interact in a wireless manner.

To achieve the objective, the repellent system includes a repellent device, a control device, a message device, and a power device. The repellent device is one for repelling or trapping animals or insects. The control device includes a processing module, a driver module, and a wireless communication module. The driver module is connected to the repellent device and is data-linked with the processing module so that status data from the repellent device is gathered and passed to the processing module. The driver module receives a control instruction from the processing module and transmits the control instruction to the repellent device. The wireless communication module is data-linked with the processing module so as to receive the status data and pass the control instruction to the processing module. The message device communicates with the wireless communication module so as to receive the status data from the wireless communication module and transmits the control instruction to the wireless communication module in a wireless manner. The power device electrically connected to the processing module so as to power the control device.

The advantages of the present invention is that a user, via the message device such as a cellular phone, obtains status data from the repellent device through the control device, and controls, configures, and adjusts the function and operation of the repellent device in a wireless and two-way interactive manner so that the convenience and applicability of the repellent device is greatly enhanced.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a functional block diagram showing a repellent system according to an embodiment of the present invention.

FIG. 2 is a circuit schematic diagram showing a repellent device of the repellent system of FIG. 1.

### DETAILED DESCRIPTION OF THE PREFERRED EMBODIMENTS

The following descriptions are exemplary embodiments only and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

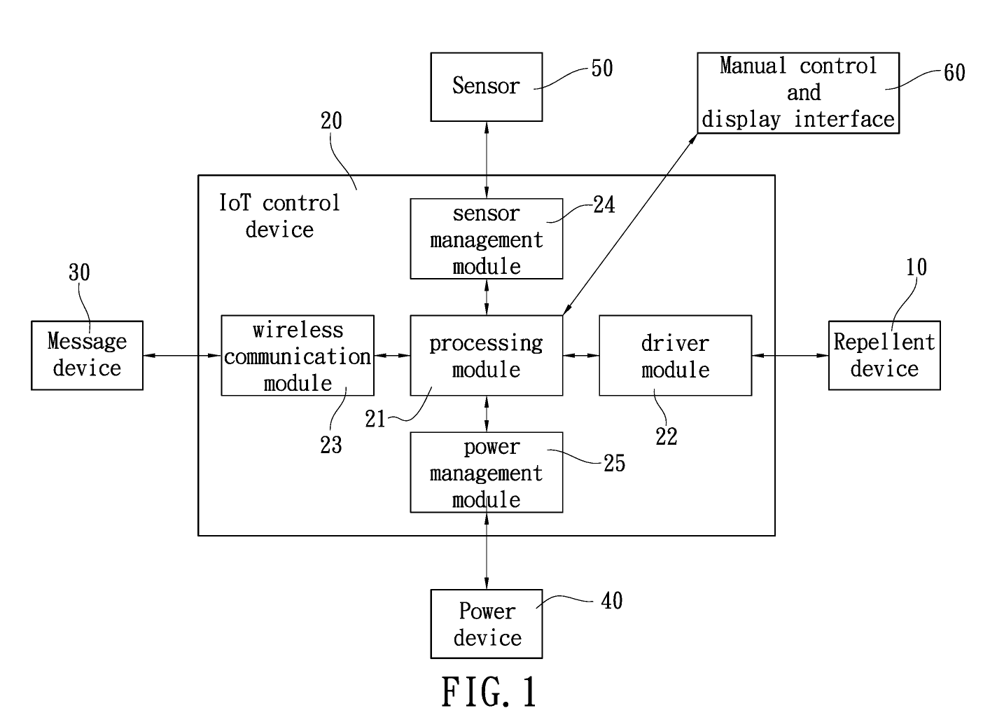

As shown in FIG. 1, a repellent system according to the present invention includes a repellent device 10, a control device 20, a message device 30, and a power device 40.

The control device 20 includes a processing module 21, a driver module 22, and a wireless communication module 23. The repellent device 10 is connected to the driver module 22 and the driver module 22 is data-linked with the processing module 21 so that status data from the repellent device 10 is gathered and passed to the processing module 21. The driver module 22 receives a control instruction from the processing module 21 and transmits the control instruction to the repellent device 10. The wireless communication module 23 is data-linked with the processing module 21 so as to receive the status data and pass the control instruction to the processing module 21.

The message device 30 communicates with the wireless communication module 23 so as to receive the status data from the wireless communication module 23 and transmits the control instruction to the wireless communication module 23.

The power device 40 is electrically connected to the processing module 21 so as to power the control device 20.

The following embodiments are exemplary only and are not intended to limit the present invention.

In one embodiment, the repellent device 10 is one of a device for repelling animals or insects and a device for trapping animals or insects.

The repellent device 10 employs one of a sonic means, a ultrasonic means, a vibration means, a lighting means, and a scent means.

In one embodiment, the control device 20 is a Internet of Things (IoT) control device.

In one embodiment, the wireless communication module 23 conforms to one of Zigbee, Radio Frequency (RF), Bluetooth, Wifi, RFID (Radio Frequency Identification), and NFC (Near Field Communication) standard.

In one embodiment, the processing module 21 is data-lined with a sensor management module 24, which in turn is connected to a sensor 50 so that the processing module 21 is able to receive a sensor signal from the sensor 50. The processing module 21 then controls the repellent device 10 to function and operate through the driver module 22.

In one embodiment, the sensor 50 detects one of light, sound, contact, electromagnetic wave, movement, and radar wave.

In one embodiment, the processing module 21 is connected to a manual control and display interface 60, which includes a hardware switch and a LED/LCD display (not shown) so as to present a status of the repellent system of the present invention.

In one embodiment, the message device 30 is one of a PDA (Personal Digital Assistant), a cellular phone, a notebook computer, a tablet computer, a gateway, a watch, a wristband, and a VR (Virtual Reality) device.

In one embodiment, the message device 30 includes a message communication module that two-way communicates with the wireless communication module 23. The message communication module conforms to one of Zigbee, Radio Frequency (RF), Bluetooth, Wifi, RFID (Radio Frequency Identification), and NFC (Near Field Communication) standard.

In one embodiment, the power device 40 is one of a AC power source, a DC power source, and a solar panel.

In one embodiment, a power management module 25 is configured between the power device 40 and the processing module 21 for managing the power device 40. More specifically, if the power device 40 is a rechargeable source, the power management module 25 provides charging management, overcharging protection, over-discharging protection, low-voltage alert, etc. The power management module 25 may receive a control instruction from the message device 30 through the processing module 21 to turn off power provisioning, or to report power status to the message device 30 through the processing module 21 and then the wireless communication module 23, so that a user may be aware of the power status.

The operation of the present invention is described as follows.

As shown in FIG. 1, a user may obtain status data from the repellent device 10 through the control device 20, and control, configure, adjust the function and operation of the repellent device 10 in a wireless and two-way interactive manner so that the convenience and applicability of the repellent device 10 is greatly enhanced.

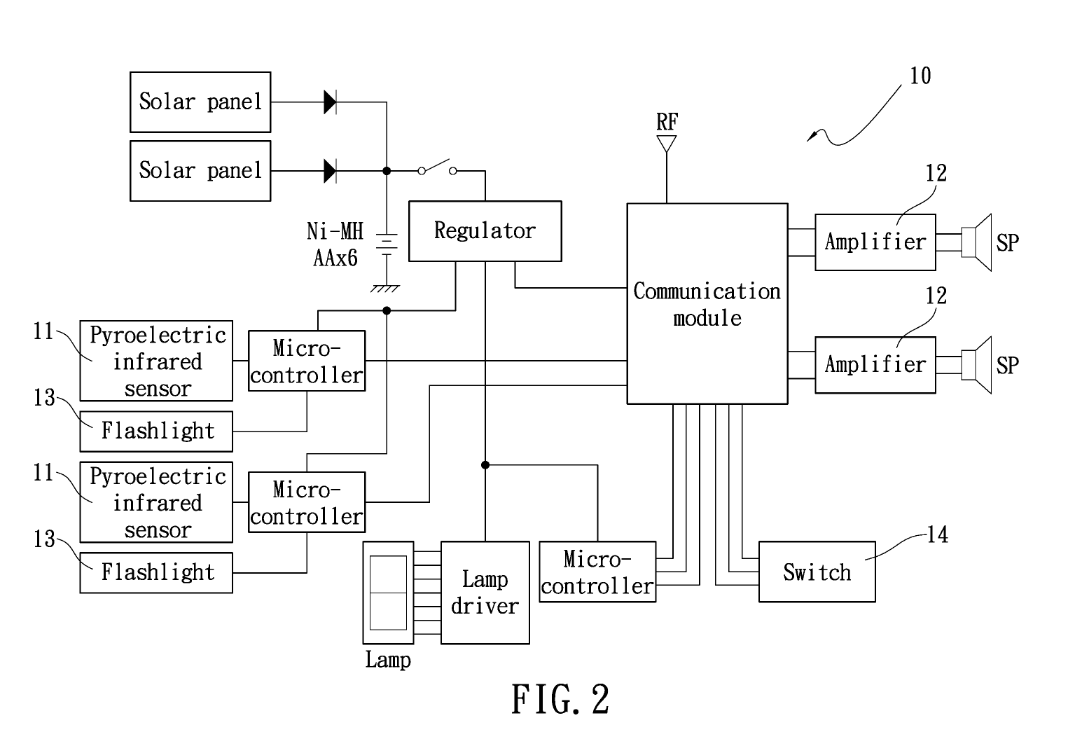

FIG. 2 is a circuit schematic diagram of the repellent device 10. As illustrated, there are a number of pyroelectric infrared sensors 11 controllable by the message device 30 through the control device 20. For example, a sensor range of each pyroelectric infrared sensor 11 is set so that when an animal or insect is within the sensor range from the repellent device 10, a repelling operation is engaged such as issuing ultrasonic waves by a number of speakers (SP) 12 or turning on a number of flashlights 13.

The message device 30 may also configure the frequency of the ultrasonic waves of the speakers (SP) 12, or the on/off patterns of the flashlights 13.

The message device 30 may also configure on/off times of a switch 14 of the repellent device 10 so that the repellent device 10 is turned on during daytime and off at night.

The message device 30 may also obtain a status of one or more batteries (e.g., six AA-sized Ni-MH rechargeable batteries) of the repellent device 10 for storing electricity from the solar panel through the control device 20 so that the batteries may be replaced at appropriate times.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

1. A repellent system, comprising
a repellent device for repelling or trapping animals or insects by one of a vibration means or a scent means;
a sensor detecting animals or insects by one of contact, movement, electromagnetic wave, and radar wave;
a control device comprising a processing module, a driver module, a sensor management module, and a wireless communication module, where the driver module is connected to the repellent device, the driver module is data-linked with the processing module so that status data from the repellent device is gathered and passed to the processing module, the driver module receives a control instruction from the processing module and transmits the control instruction to the repellent device, the wireless communication module is data-linked with the processing module so as to receive the status data and pass the control instruction to the processing module, the sensor management module is data-linked with the processing module, and the sensor management module is connected to the sensor so that the processing module receives a sensor signal from the sensor and accordingly controls the repellent device to operate through the driver module;
a message device communicating with the wireless communication module so as to receive the status data from the wireless communication module and transmits the control instruction to the wireless communication module in a wireless manner; and
a power device electrically connected to the processing module so as to power the control device;

2.-3. (canceled)

4. The repellent system according to claim 1, wherein the control device is an Internet of Things (IoT) control device.

5. The repellent system according to claim 1, wherein the wireless communication module conforms to one of Zigbee, Radio Frequency (RF), Bluetooth, Wifi, Radio Frequency Identification (RFID), and Near Field Communication (NFC) standard.

6.-7. (canceled)

8. The repellent system according to claim 1, further comprising a manual control and display interface connected to the processing module wherein the manual control and display interface comprises a hardware switch and a LED/LCD display.

9. The repellent system according to claim 1, wherein the message device is one of a Personal Digital Assistant (PDA), a cellular phone, a notebook computer, a tablet computer, a gateway, a watch, a wristband, and a Virtual Reality (VR) device.

10. The repellent system according to claim 1, wherein the message device comprises a message communication module two-way communicating with the wireless communication module; and the message communication module conforms to one of Zigbee, Radio Frequency (RF), Bluetooth, Wifi, Radio Frequency Identification (RFID), and Near Field Communication (NFC) standard.

11. The repellent system according to claim 1, wherein the power device is one of an AC power source, a DC power source, and a solar panel.

12. The repellent system according to claim 1, wherein the control device further comprises a power management module configured between the power device and the processing module for managing the power device.
